(19) United States
(12) Patent Application Publication
(10) Pub. No.: US 2017/0186080 A1
(43) Pub. Date: Jun. 29, 2017

(54) SHOPPING SUPPORT SYSTEM AND SERVER

(71) Applicant: TOSHIBA TEC KABUSHIKI KAISHA, Tokyo (JP)

(72) Inventor: Toshihiko Furuya, Sunto Shizuoka (JP)

(21) Appl. No.: 15/376,783

(22) Filed: Dec. 13, 2016

(30) Foreign Application Priority Data
Dec. 25, 2015 (JP) 2015-254696

(51) Int. Cl. G06Q 30/06; G06F 3/14

(52) U.S. Cl. CPC G06Q 30/0643; G06Q 30/0625; G06F 3/14

(57) ABSTRACT

A registration information reading section reads hobby and taste information or desired commodity information, i.e., registration information of a customer, which is registered in a first portable terminal carried by the customer. A specific commodity retrieval section collates the read registration information with a commodity arrangement database to retrieve a specific commodity relating to the registration information. A specific commodity detection section compares a position of the first portable terminal specified by the customer position determination section with a display position of the specific commodity stored in the commodity arrangement database in the store to detect whether or not the customer is located nearby the specific commodity. A display image generation section generates a display image indicating a display state of the specific commodity if the customer is located nearby the specific commodity. An image presentation section presents the display image to the customer.

### CROSS-REFERENCE TO RELATED APPLICATION

This application is based upon and claims the benefit of priority from Japanese Patent Application No. 2015-254696, filed Dec. 25, 2015, the entire contents of which are incorporated herein by reference.

### FIELD

Embodiments described herein relate generally to a shopping support system and a server.

### BACKGROUND

Conventionally, when doing the shopping at a store, a customer notes or memorizes commodities to be purchased in advance and buys a desired commodity relying on the note or the memory. However, it is difficult to obtain information of, for example, commodities relating to a hobby (favorite items) and a taste of the customer.

### DESCRIPTION OF THE DRAWINGS

FIG. 1 is a block diagram illustrating the hardware arrangement of a server system constituting a shopping support system according to a first embodiment of the present invention;

FIG. 2 is a block diagram illustrating the hardware arrangement of a portable terminal carried by a customer;

FIG. 3 is a block diagram illustrating the functional arrangement of the shopping support system;

FIG. 4 is a diagram illustrating an example of an arrangement image;

FIG. 5 is a diagram illustrating an example of a display image;

FIG. 6-1 is a flowchart illustrating the flow of a processing from a moment the customer enters a store to a moment the arrangement image of a specific commodity is presented to the portable terminal of the customer;

FIG. 6-2 is a flowchart illustrating the flow of a processing from a moment the arrangement image of the specific commodity is presented to the portable terminal of the customer to a moment the display image of the specific commodity is presented thereto;

FIG. 7 is a block diagram illustrating the functional arrangement of a shopping support system according to a second embodiment of the present invention;

FIG. 8-1 is a flowchart illustrating the flow of a processing from a moment the customer enters a store to a moment the arrangement image of a specific commodity is presented to a portable terminal of the customer; and

FIG. 8-2 is a flowchart illustrating the flow of a processing from a moment the arrangement image of the specific commodity is presented to the portable terminal of the customer to a moment the display image of the specific commodity is presented thereto.

### DETAILED DESCRIPTION

In accordance with an embodiment, a shopping support system comprises a registration information reading section, a commodity arrangement database, a customer position determination section, a specific commodity retrieval section, a specific commodity detection section, a display image generation section and an image presentation section. The registration information reading section reads registration information from an information holding module, in which the registration information of a customer is registered, carried by the customer. The commodity arrangement database stores shelf allocation of commodities in a store. The customer position determination section specifies a position of the customer in the store. The specific commodity retrieval section retrieves a specific commodity relating to the registration information of the customer and a display position of the specific commodity in the store from the commodity arrangement database. The specific commodity detection section detects whether or not there is the specific commodity in the vicinity of the customer. The display image generation section generates a display image indicating a display state of the specific commodity if the specific commodity is detected in the vicinity of the customer. The image presentation section presents the display image to the customer.

In accordance with an embodiment, a server comprises a registration information reading section, a commodity arrangement database, a customer position determination section, a specific commodity retrieval section, a specific commodity detection section, a display image generation section and an image presentation section. The registration information reading section reads registration information from an information holding module, in which the registration information of a customer is registered, carried by the customer. The commodity arrangement database stores shelf allocation of commodities in a store. The customer position determination section specifies a position of the customer in the store. The specific commodity retrieval section retrieves a specific commodity relating to the registration information of the customer and a display position of the specific commodity in the store from the commodity arrangement database. The specific commodity detection section detects whether or not there is the specific commodity in the vicinity of the customer. The display image generation section generates a display image indicating a display state of the specific commodity if the specific commodity is detected in the vicinity of the customer.

### First Embodiment

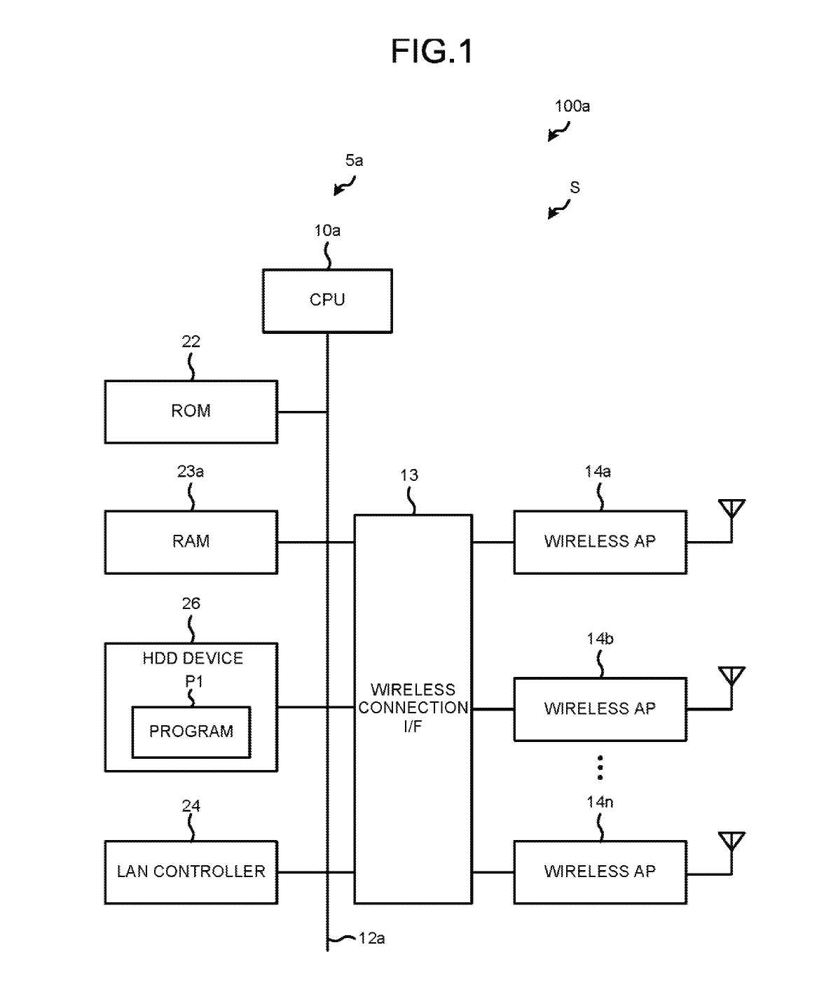

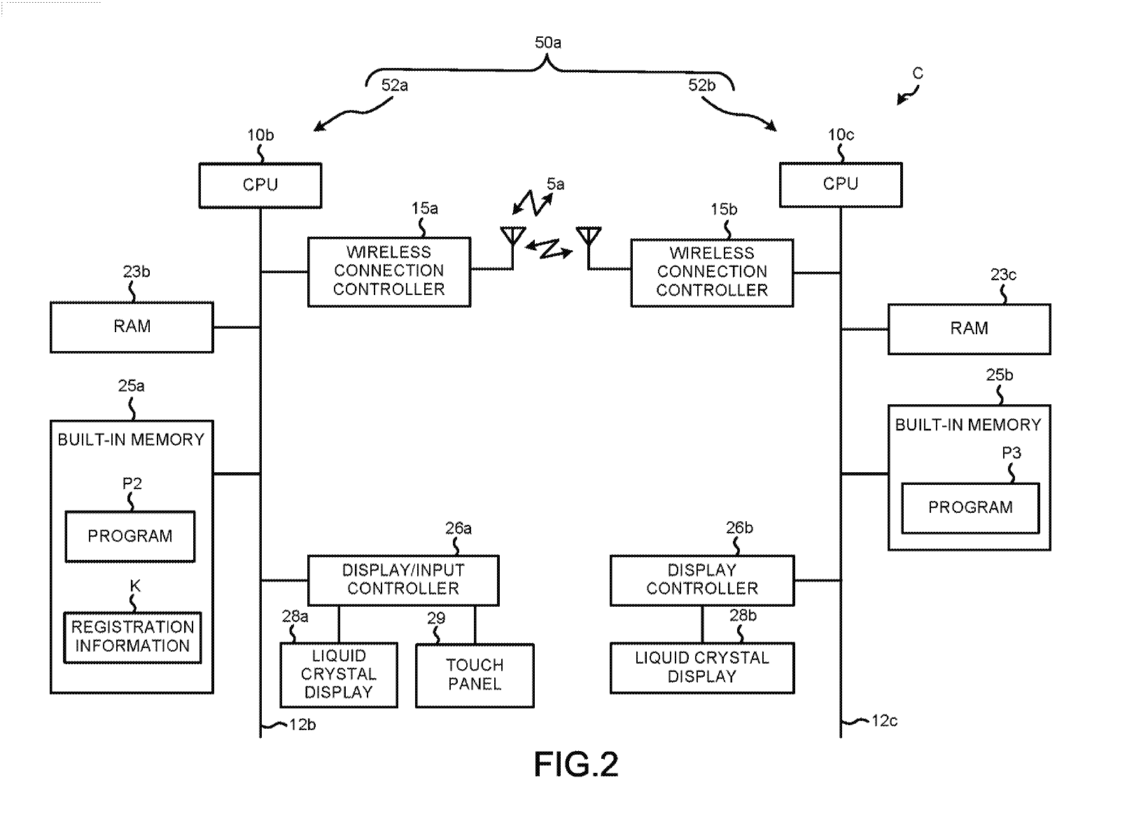

A shopping support system 100a according to the first embodiment of the present invention is described with reference to the accompanying drawings. The invention is not limited by the present embodiment. FIG. 1 is a block diagram illustrating the hardware arrangement of a server system 5a constituting the shopping support system 100a according to the first embodiment. FIG. 2 is a block diagram illustrating the hardware arrangement of a portable terminal 50a carried by a customer C.

The shopping support system 100a includes a server system (hereinafter, referred to as a server) 5a arranged in a store S as shown in FIG. 1. The server 5a includes a constitution of a general computer system in which a CPU (Central Processing Unit) 10a serving as a main controller executes a program P1. The server 5a supplies information for supporting a shopping according to a request of the portable terminal 50a (FIG. 2) carried by the customer C at the time the customer C does the shopping in the store S.

The server 5a includes a wireless connection I/F (Interface) 13 for respectively connecting with a plurality of wireless APs (access points) 14a-14n arranged at specific positions of the store S via a bus line 12a. The CPU 10a is respectively connected with a ROM (Read Only Memory) 22, a RAM (Random. Access Memory) 23a, an HDD (Hard Disk Drive) device 26 and an LAN (Local Area Network) controller 24 via the bus line 12a.

The RAM 23a, i.e., a main storage device, functions as a temporary storage section of an arithmetic result when the CPU 10a carries out an arithmetic processing. The ROM 22 and the HDD device 26 are auxiliary storage devices. The ROM 22 stores data required for the arithmetic processing carried out by the CPU 10a. The HDD device 26 stores the program P1 executed by the CPU 10a. The LAN controller 24 connects the server 5a with another computer not shown in FIG. 1 via a network.

The program P1 executed by the CPU 10a is recorded in a computer-readable recording medium such as a CD-ROM, an FD (Flexible Disk), a CD-R and a DVD (Digital Versatile Disc) in the form of installable or executable file to be provided. Further, the program P1 may be stored on a computer connected with a network such as an Internet in advance and downloaded to the server 5a via the network. The read program. P1 is stored in the HDD device 26.

The server 5a is connected with the portable terminal 50a (FIG. 2) carried by the customer C through a wireless LAN (for example, Wi-Fi (registered trademark)) via the wireless APs (Access Points) 14a-14n.

The portable terminal 50a includes a smartphone (hereinafter, referred to as a first portable terminal) 52a and a wristwatch type portable terminal (hereinafter, referred to as a second portable terminal) 52b wirelessly connected with the first portable terminal 52a in advance, both of which are carried by the customer C, as shown in FIG. 2. The first portable terminal 52a is wirelessly connected with the server 5a. It is desirable that the second portable terminal 52b is a so-called wearable terminal which can be worn and used by the customer C, but the second portable terminal 52b may be an eyeglasses type portable terminal or a wristband type portable terminal in addition to the wristwatch type portable terminal. In the present embodiment, the first portable terminal 52a serves as an information holding module, and includes a built-in memory 25a for registering hobby and taste information or favorable commodity information (hereinafter, referred to as registration information) of the customer C. The second portable terminal 52b may serve as the information holding module, instead of the first portable terminal.

The first portable terminal 52a includes a constitution of a general computer system in which a CPU 10b serving as a main controller executes a program P2. The CPU 10b is connected with a wireless connection controller 15a via a bus line 12b. The first portable terminal 52a is wirelessly connected with the server 5a and the second portable terminal 52b respectively via the wireless connection controller 15a. Further, the CPU 10b is connected with a RAM 23b and the built-in memory 25a respectively via the bus line 12b.

The RAM 23b, i.e, a main storage device, functions as a temporary storage section of an arithmetic result when the CPU 10b carries out an arithmetic processing. The built-in memory 25a, i.e., an auxiliary storage device, is constituted by, for example, a flash memory, to store the program P2 executed by the CPU 10b and registration information K of the customer C.

The CPU 10b is further connected with a liquid crystal display 28a and a touch panel 29 via a display/input controller 26a.

The second portable terminal 52b includes a general computer system in which a CPU 10c serving as a main controller executes a program P3. The CPU 10c is connected with a wireless connection controller 15b via a bus line 12c. The CPU 10c is connected with a RAM 23c and a built-in memory 25b (for example, a flash memory) respectively via the bus line 12c. The CPU 10c is further connected with a liquid crystal display 28b via a display controller 26b.

The RAM 23c, i.e., a main storage device, functions as a temporary storage section of an arithmetic result when the CPU 10c carries out an arithmetic processing. The built-in memory 25b, an auxiliary storage device, stores the program P3 executed by the CPU 10c.

The programs P2 and P3 are supplied from the store S, for example, at the time the customer C becomes a member of the store S. The supplied programs P2 and P3 are acquired in such a manner that the customer C downloads the programs P2 and P3 from the server 5a directly. Alternatively, the supplied programs P2 and P3 may be acquired in such a manner that the customer C accesses the server 5a via the Internet at home to download the programs P2 and P3. The downloaded program P2 is stored in the built-in memory 25a of the first portable terminal 52a. Further, the downloaded program P3 is stored in the built-in memory 25b of the second portable terminal 52b.

Next, an arrangement image generation processing and a display image generation processing, i.e., characteristic processing, of the present embodiment among the processing executed by the shopping support system 100a are described.

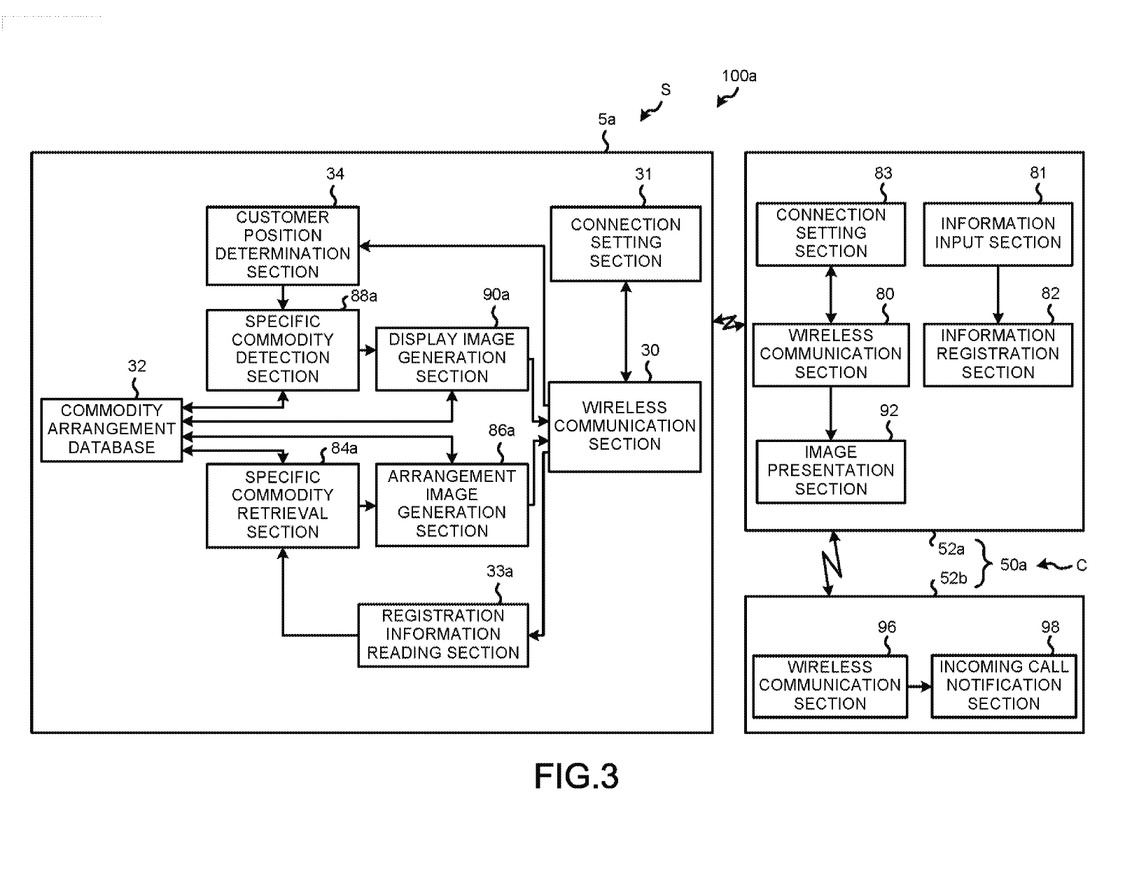

FIG. 3 is a block diagram illustrating the functional arrangement of the shopping support system 100a. The CPU 10a of the server 5a operates according to the program. P1 to enable a wireless communication section 30, a connection setting section 31, a commodity arrangement database 32, a registration information reading section 33a, a customer position determination section 34, a specific commodity retrieval section 84a, an arrangement image generation section 86a, a specific commodity detection section 88a and a display image generation section 90a shown in FIG. 3 to operate as functional sections.

The CPU 10b of the first portable terminal 52a operates according to the program P2, to enable a wireless communication section 80, an information input section 81, an information registration section 82, a connection setting section 83 and an image presentation section 92 shown in FIG. 3 to operate as functional sections.

The CPU 10c of the second portable terminal 52b operates according to the program P3, to enable a wireless communication section 96 and an incoming call notification section 98 shown in FIG. 3 to operate as functional sections.

The wireless communication section 30 included in the server 5a carries out communication with the first portable terminal 52a via the plurality of the wireless APs 14a-14n (FIG. 1) connected with the wireless connection I/F 13. The connection setting section 31 connects the server 5a with the first portable terminal 52a.

The commodity arrangement database 32 is stored in the HDD device 26 (FIG. 1). The commodity arrangement database 32 includes names of commodities sold in the store S and images indicating appearances of the commodities. Furthermore, the commodity arrangement database 32 includes shelf allocation information of each commodity in the store S (indicating the floor number and the shelf number (n-th floor and n-th shelf) on which each commodity is displayed, and the location (n-th row from the top, and n-th column from the left side, for example) at which each commodity is positioned). Furthermore, all commodities are respectively assigned with keywords for characterizing the commodities. The keyword is set as a name capable of being collated with the hobby and taste information registered by the customer C. For example, the commodities used to a diving, e.g., a scuba diving, are previously assigned with a plurality of keywords such as “diving”, “sea”, “leisure” and the like associated with the diving.

The registration information reading section 33a reads the registration information K registered in the built-in memory 25a by the customer C through the information registration section 82.

The customer position determination section 34 specifies a position of the first portable terminal 52a in the store S, for example, by carrying out an indoor positioning using Wi-Fi (registered trademark). As the customer C carries the first portable terminal 52a, the first portable terminal 52a is located at the same position as the customer C. In other words, the customer position determination section 34 sets the specified position of the first portable terminal 52a as the position of the customer C in the store S. Firstly, the customer position determination section 34 respectively measures radio wave intensity when each of the wireless APs 14a-14n carries out communication with the first portable terminal 52a. Then, on the basis of each measured radio wave intensity, the customer position determination section 34 specifies a relative position of the first portable terminal 52a to each of the wireless APs 14a-14n. The customer position determination section 34 specifies the position of the first portable terminal 52a (position of the customer C) in the store S on the basis of the specified relative position of the first portable terminal 52a and each arrangement position of the wireless APs 14a-14n. On the other hand, the customer position determination section 34 may specify a position of the customer C by specifying a position of the second portable terminal 52b.

The configuration of the customer position determination section 34 is not limited to that described above. For example, the position of the first portable terminal 52a may be specified by a GPS (Global Positioning System) positioning function the first portable terminal 52a has, and the specified position may be sent to the server 5a. At a place like an underground floor where the GPS positioning is difficult due to weak radio waves, the positioning may be carried out by arranging a base station which transmits a signal having positional information. Such an indoor positioning technology called IMES (Indoor Messaging System) can specify the position of the first portable terminal 52a by receiving the signal transmitted by the base station with the first portable terminal 52a.

The specific commodity retrieval section 84a collates the registration information K registered in the built-in memory 25a by the customer C through the information registration section 82 with the keyword or the commodity information assigned to each commodity registered in the commodity arrangement database 32. Then, the specific commodity retrieval section 84a respectively retrieves a specific commodity M similar or coincident with (relating to) the registration information K of the customer C and a display position of the specific commodity M.

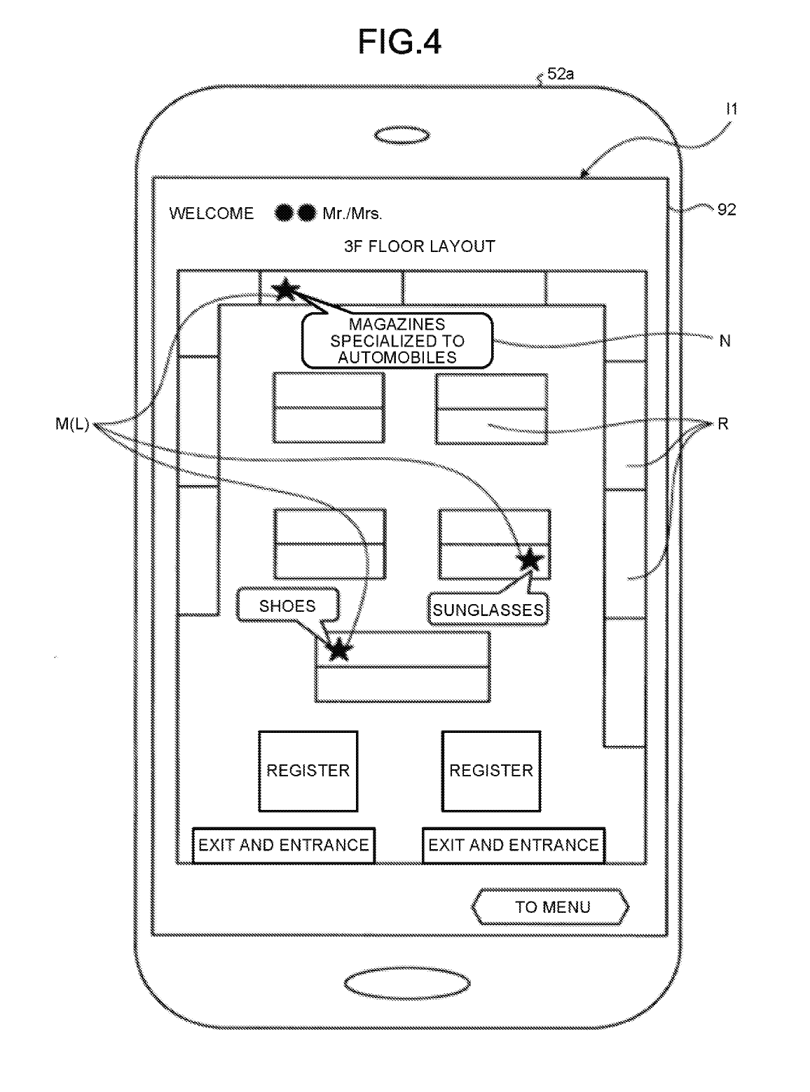

The arrangement image generation section 86a generates an arrangement image I1 (FIG. 4) indicating the display position of the specific commodity M in the store S (arrangement image generation processing).

The specific commodity detection section 88a detects whether or not there is the specific commodity M in the vicinity (for example, within 10 m) of the first portable terminal 52a by comparing the position of the first portable terminal 52a (position of the customer C) in the store S with the display position of the specific commodity M.

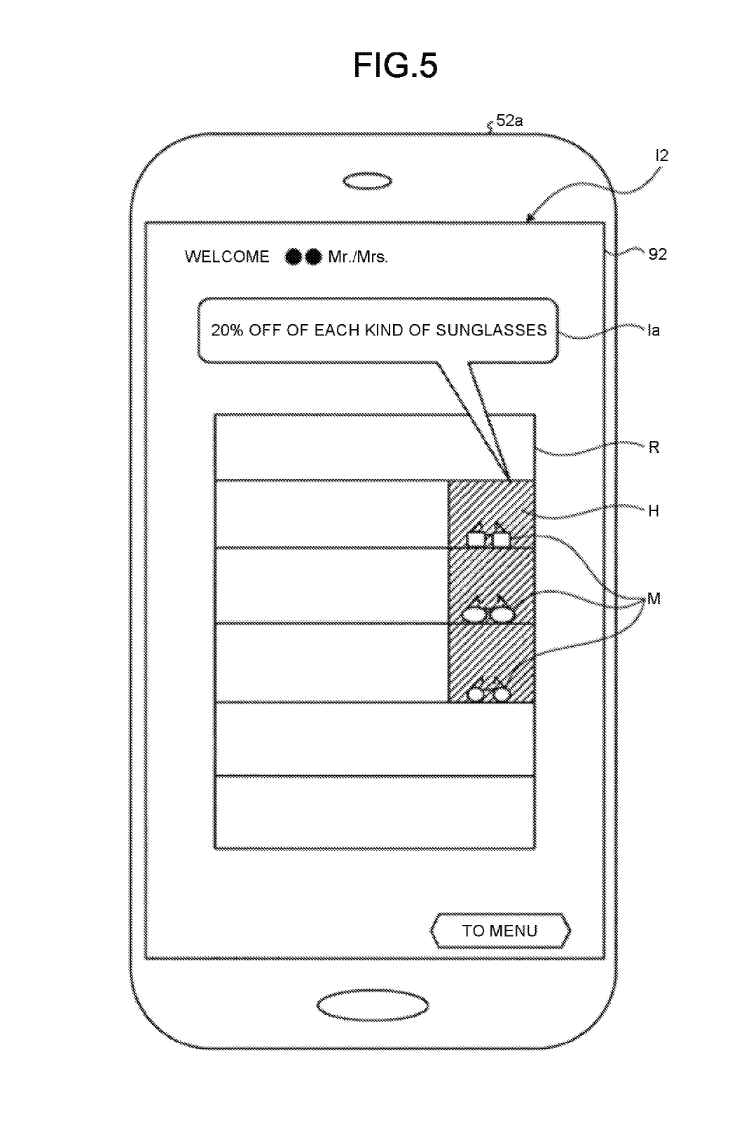

The display image generation section 90a generates a display image I2 (FIG. 5) indicating a display state of the specific commodity M if the specific commodity detection section 88a detects that there is the customer C in the vicinity of the specific commodity M (display image generation processing).

The wireless communication section 80 included in the first portable terminal 52a carries out communication with the server 5a and the second portable terminal 52b. The arrangement image I1 or the display image I2 sent from the server 5a is received via the wireless communication section 80. Furthermore, the reception of the arrangement image I1 or the display image I2 is informed to the second portable terminal 52b via the wireless communication section 80.

The information input section 81 inputs the registration information K of the customer C to the first portable terminal 52a via the touch panel 29 (FIG. 2) of the first portable terminal 52a.

The information registration section 82 stores the registration information K of the customer C. The hobby and taste information in the registration information K relates to a hobby and a taste of the customer C such as “drive, golf and photograph”. Further, the desired commodity information in the registration information K is information of commodities that the customer C is interested in such as “a commodity a of a new product and a commodity b in autumn season”, or information of commodities that the customer C wants to purchase such as “a commodity c and a commodity d”.

The connection setting section 83 connects the first portable terminal 52a with the server 5a. Further, the connection setting section 83 connects the first portable terminal 52a with the second portable terminal 52b.

The image presentation section 92 presents the arrangement image I1 or the display image I2 received from the server 5a by the first portable terminal 52a to the customer C.

The wireless communication section 96 included in the second portable terminal 52b carries out communication with the first portable terminal 52a. The second portable terminal 52b receives a signal for informing that the first portable terminal 52a receives the arrangement image I1 or the display image I2 via the wireless communication section 96.

The incoming call notification section 98 notifies the customer C of the presentation of the arrangement image I1 or the display image I2 to the image presentation section 92. A concrete notification method may display a message on the second portable terminal 52b or blink an indicator included in the second portable terminal 52b. Alternatively, vibration may be applied to the second portable terminal 52b.

Next, concrete examples of the arrangement image I1 and the display image I2 presented to the customer C by the shopping support system 100a are described with reference to a case in which the customer C registers the keyword “drive” in the information registration section 82 as the hobby and taste information.

(Example of Arrangement Image I1)

The specific commodity retrieval section 84a collates the keyword assigned to each commodity registered in the commodity arrangement database 32 with the hobby and taste information “drive” registered by the customer C. In the present embodiment, the specific commodity retrieval section 84a retrieves a commodity relating to the “drive”, for example, “sunglasses, shoes, and magazines specialized to automobiles” as the specific commodity M.

FIG. 4 is a diagram illustrating the example of the arrangement image I1 generated by the arrangement image generation section 86a. As shown in FIG. 4, the arrangement image I1 includes the arrangement of commodity shelves R in the store S, names N and display positions L of the retrieved specific commodities M. The customer C can grasp the display positions of the specific commodities M relating to the “drive” by observing arrangement image I1. Then, the customer C can arrive without hesitation at the display position of the specific commodity M that the customer C wants to pick up and confirm actually. Further, although not shown in FIG. 4, the current position of the customer C is superimposed with the arrangement image I1 and may display them.

(Example of Display Image I2)

The specific commodity detection section 88a compares the position of the first portable terminal 52a in the store S with the display position of the specific commodities M included in the commodity arrangement database 32.

When the specific commodity detection section 88a detects that there is the first portable terminal 52a in the vicinity of the display position of one of the specific commodities M, in other words, if the customer C approaches the vicinity of one of the specific commodities M, the display image generation section 90a generates the display image I2 indicating the display state of the specific commodity M on the basis of the shelf allocation information of the specific commodities M included in the commodity arrangement database 32.

FIG. 5 is a diagram illustrating the example of the generated display image I2. As shown in FIG. 5, the display image I2 is an image indicating a state in which the specific commodities M (the same kind of specific commodity) are practically allocated on the commodity shelf R. In the display image I2, a front view of the commodity shelf R on which the specific commodities M are displayed is displayed, and images indicating the appearances of the specific commodities M are superimposed with the display positions of the specific commodities M. Further, in order to emphasize the specific commodities M, hatching H is applied to the display positions of the specific commodities M. Furthermore, in the display image I2, incidental information Ia such as bargain sale information relating to the specific commodity M is superimposed. The customer C can easily find the specific commodities M by comparing the display image I2 with the commodity shelves R around the current position of the customer C with his or her eyes.

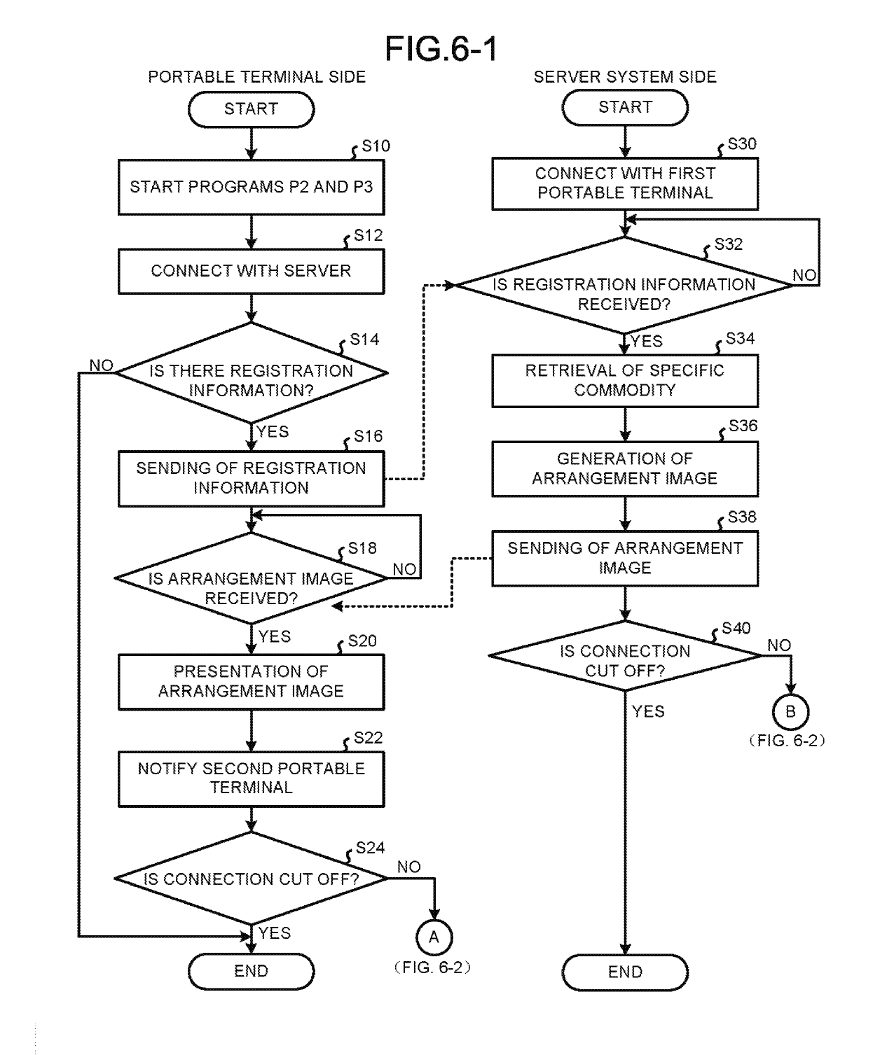

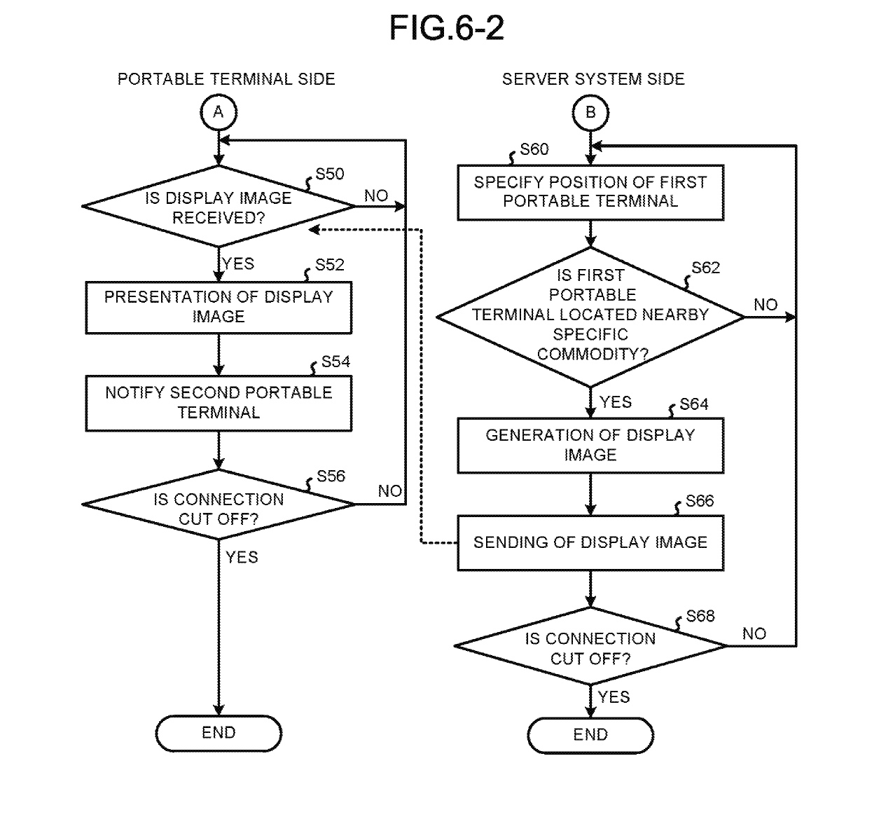

Next, the flow of the processing carried out by the shopping support system 100a is described with reference to flowcharts in FIG. 6-1 and FIG. 6-2. FIG. 6-1 illustrates the flow of the processing from a moment the customer C enters the store to a moment the arrangement image I1 is presented to the first portable terminal 52a. FIG. 6-2 illustrates the flow of the processing from a moment the arrangement image I1 is presented to the first portable terminal 52a to a moment the display image I2 is presented thereto.

The first portable terminal 52a receives an instruction by the customer C who comes to the store S to start the program P2 (FIG. 2), and furthermore, to start the program P3 (FIG. 2) of the second portable terminal 52b wirelessly connected with the first portable terminal 52a in advance (ACT S10). Then, the connection setting section 83 of the first portable terminal 52a connects the first portable terminal 52a with the server 5a via the wireless AP with the strongest radio wave intensity among the plurality of the wireless APs 14a-14n (FIG. 1) (ACT S12).

The first portable terminal 52a confirms whether or not the registration information K of the customer C is registered in the information registration section 82 (ACT S14). If the registration information K of the customer C is registered (YES in ACT S14), a processing in ACT S16 is executed, or if registration information K of the customer C is not registered (No in ACT S14), the processing in FIG. 6-1 is ended.

The first portable terminal 52a sends the registration information K of the customer C to the server 5a (ACT S16). The wireless communication section 80 confirms whether or not the arrangement image I1 is received from the server 5a (ACT S18). If the arrangement image I1 is received (YES in ACT S18), a processing in ACT S20 is executed, or if the arrangement image I1 is not received (No in ACT S18), the processing in ACT S18 is repeated.

The first portable terminal 52a presents the arrangement image I1 to the image presentation section 92 (ACT S20). Then, the first portable terminal 52a notifies the second portable terminal 52b of the presentation of the arrangement image I1 (ACT S22).

The first portable terminal 52a confirms whether or not the connection with the server 5a is cut off (ACT S24). If the connection is cut off (YES in ACT S24), the processing in FIG. 6-1 is ended, or if the connection is not cut off (No in ACT S24), a processing in ACT S50 is executed (FIG. 6-2).

The connection setting section 31 of the server 5a connects the server 5a with the first portable terminal 52a (ACT S30). The wireless communication section 30 confirms whether or not the registration information K of the customer C is received from the first portable terminal 52a (ACT S32). If the registration information K is received (YES in ACT S32), a processing in ACT S34 is executed, or if the registration information K is not received (No in ACT S32), the processing in ACT S32 is repeated.

The specific commodity retrieval section 84a retrieves the specific commodity M (ACT S34). Then, the arrangement image generation section 86a generates the arrangement image I1 on the basis of a retrieval result of the specific commodity M (ACT S36). Next, the arrangement image generation section 86a sends the arrangement image I1 to the first portable terminal 52a (ACT S38).

The server 5a confirms whether or not the connection with the first portable terminal 52a is cut off (ACT S40). If the connection is cut off (YES in ACT S40), the processing in FIG. 6-1 is ended, or if the connection is not cut off (No in ACT S40), a processing in ACT S60 is executed (FIG. 6-2).

The wireless communication section 80 confirms whether or not the display image I2 is received from the server 5a (ACT S50). If the display image I2 is received (YES in ACT S50), a processing in ACT S52 is executed, or if the display image I2 is not received (No in ACT S50), the processing in ACT S50 is repeated.

The first portable terminal 52a presents the display image I2 to the image presentation section 92 (ACT S52). Then, the first portable terminal 52a notifies the second portable terminal 52b of the presentation of the display image I2 (ACT S54).

The first portable terminal 52a confirms whether or not the connection with the server 5a is cut off (ACT S56). If the connection is cut off (YES in ACT S56), the processing in FIG. 6-2 is ended, or if the connection is not cut off (No in ACT S56), the processing in ACT S50 is re-executed.

The customer position determination section 34 specifies the position of the first portable terminal 52a in the store S (ACT S60). Then, the specific commodity detection section 88a detects whether or not the first portable terminal 52a is located in the vicinity of the specific commodity M (ACT S62). If the first portable terminal 52a is located in the vicinity of the specific commodity M (YES in ACT S62), a processing in ACT S64 is executed, or if the first portable terminal 52a is not located in the vicinity of the specific commodity M (No in ACT S62), the processing in ACT S60 is re-executed.

The display image generation section 90a generates the display image I2 (ACT S64). Furthermore, the display image generation section 90a sends the display image I2 to the first portable terminal 52a (ACT S66).

The server 5a confirms whether or not the connection with the first portable terminal 52a is cut off (ACT S68). If the connection is cut off (YES in ACT S68), the processing in FIG. 6-2 is ended, or if the connection is not cut off (No in ACT S68), the processing in ACT S60 is re-executed.

In this way, according to the shopping support system 100a of the first embodiment, the registration information reading section 33a reads the hobby and taste information or the desired commodity information (registration information K) of the customer C registered in the first portable terminal 52a (information holding module) carried by the customer C. The specific commodity retrieval section 84a collates the read registration information K with the commodity arrangement database 32 to retrieve the specific commodity M relating to the registration information K. The specific commodity detection section 88a detects whether or not the customer C is located in the vicinity of the specific commodity M by comparing the position of the first portable terminal 52a (position of the customer C) specified by the customer position determination section 34 with the display position of the specific commodity M stored in the commodity arrangement database 32 in the store S. The display image generation section 90a generates the display image I2 indicating the display state of the specific commodity M and then presents the generated display image I2 to the image presentation section 92 if the customer Cis located in the vicinity of the specific commodity M. As the display image I2 indicating the actual display state is presented, the customer C can easily find the specific commodity M. Furthermore, the customer C can be prevented from forgetting to buy a target commodity, and thus can spend a shorter time when searching a commodity concerned. In particular, when the customer C comes to the store S for the first time, the customer C does not grasp the arrangement of the commodities in the store S, and thus the shopping support system 100a further exerts the above-mentioned effects.

According to the shopping support system 100a of the first embodiment, the arrangement image generation section 86a generates the arrangement image I1 indicating the display position of the specific commodity M in the store S, and then presents the generated arrangement image I1 to the image presentation section 92. Therefore, if a plurality of the specific commodities M is retrieved, the customer C can determine the order of shopping in advance, and thus can do the shopping efficiently.

According to the shopping support system 100a of the first embodiment, the image presentation section 92 presents the display image I2 or the arrangement image I1 to the first portable terminal 52a (e.g., smartphone) carried by the customer C, and informs the customer C that the display image I2 or the arrangement image I1 is presented to the second portable terminal 52b (e.g., wristwatch type portable terminal). Thus, even if the customer C does not see the first portable terminal 52a, the customer C can immediately notice that the display image I2 or the arrangement image I1 is presented. Further, as the state of the first portable terminal 52a is not always cared, the customer C can do the shopping at his or her own pace.

According to the shopping support system 100a of the first embodiment, the customer position determination section 34 specifies the position of the customer C in the store S by specifying the position of the first portable terminal 52a carried by the customer C. Therefore, the customer C can obtain the commodity information relating to the specific commodity M on the first portable terminal 52a carried by himself/herself in the store S without carrying out any special operation.

Further, according to the server 5a (server system) of the first embodiment, the server 5a includes the registration information reading section 33a, the commodity arrangement database 32, the customer position determination section 34, the specific commodity retrieval section 84a, the specific commodity detection section 88a and the display image generation section 90a. For that reason, it is unnecessary that the first portable terminal 52a generates the display image I2. Therefore, it is possible to suppress that the load of the processing of the first portable terminal 52a carried by the customer C is increased.

Furthermore, in the shopping support system 100a of the first embodiment, the second portable terminal 52b only notifies reception of the arrangement image I1 or the display image I2, but after the arrangement image I1 is presented, a direction and a distance from the current position to the display position of the specific commodity M may be displayed on the second portable terminal to guide the customer C to the display position of the specific commodity M.

### Second Embodiment

Next, the second embodiment is described. The second embodiment is different from the first embodiment in that apart of the processing carried out by the server 5a in the first embodiment is carried out by a portable terminal 50b, e.g., smartphone, (hereinafter, referred to as a first portable terminal) 52c, and a portable terminal 52b, e.g., wristwatch type portable terminal (hereinafter, referred to as a second portable terminal). In the following description, the same part as the above-mentioned first embodiment is denoted with the same reference numerals.

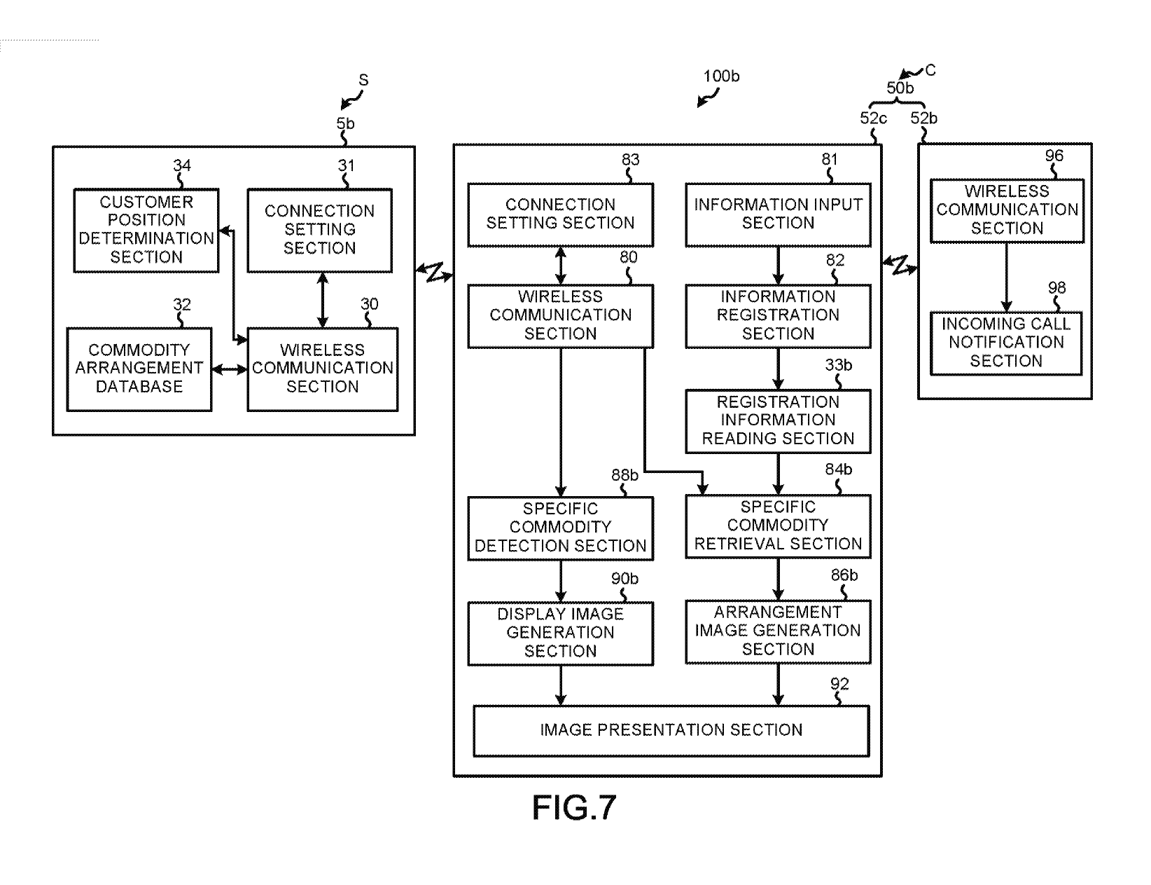

FIG. 7 is a block diagram illustrating the functional arrangement of a shopping support system 100b. The shopping support system 100b includes a server system (hereinafter, referred to as a server) 5b arranged in the store S and the portable terminal 50b carried by the customer C. The hardware arrangement of the shopping support system 100b according to the second embodiment is identical to the hardware arrangement (FIG. 1 and FIG. 2) of the shopping support system 100a. Therefore, the related hardware is described with reference to the reference numerals in FIG. 1 and FIG. 2.

The server 5b includes the wireless communication section 30, the connection setting section 31, the commodity arrangement database 32 and the customer position determination section 34.

The first portable terminal 52c of the portable terminal 50b includes a registration information reading section 33b, a specific commodity retrieval section 84b, an arrangement image generation section 86b, a specific commodity detection section 88b and a display image generation section 90b in addition to the components included in the first portable terminal 52a (FIG. 2) described in the first embodiment. The functional arrangement of the second portable terminal 52b of the portable terminal 50b is identical to that in the first embodiment.

The first portable terminal 52c respectively receives contents of the commodity arrangement database 32 stored in the server 5b and a position of the first portable terminal 52c (position of the customer C) specified by the server 5b in the store S.

The registration information reading section 33b reads the registration information K registered in the information registration section 82 of the first portable terminal 52c by the customer C.

The specific commodity retrieval section 84b collates the contents of the commodity arrangement database 32 with the registration information K previously registered in the information registration section 82 by the customer C to retrieve the specific commodity M in the same way as that described in the first embodiment. The arrangement image generation section 86b generates the arrangement image I1 indicating the display position of the retrieved specific commodity M.

The specific commodity detection section 88b detects whether or not the specific commodity M is located in the vicinity of the customer C on the basis of the position of the first portable terminal 52c (position of the customer C) in the store S. Then, if it is detected that the specific commodity M is located in the vicinity (for example, within 10 m) of the customer C, the display image generation section 90b generates the display image I2 indicating the display state of the specific commodity M. Then, the image presentation section 92 presents the arrangement image I1 or the display image I2 to the customer C, that is, on the first portable terminal 52C.

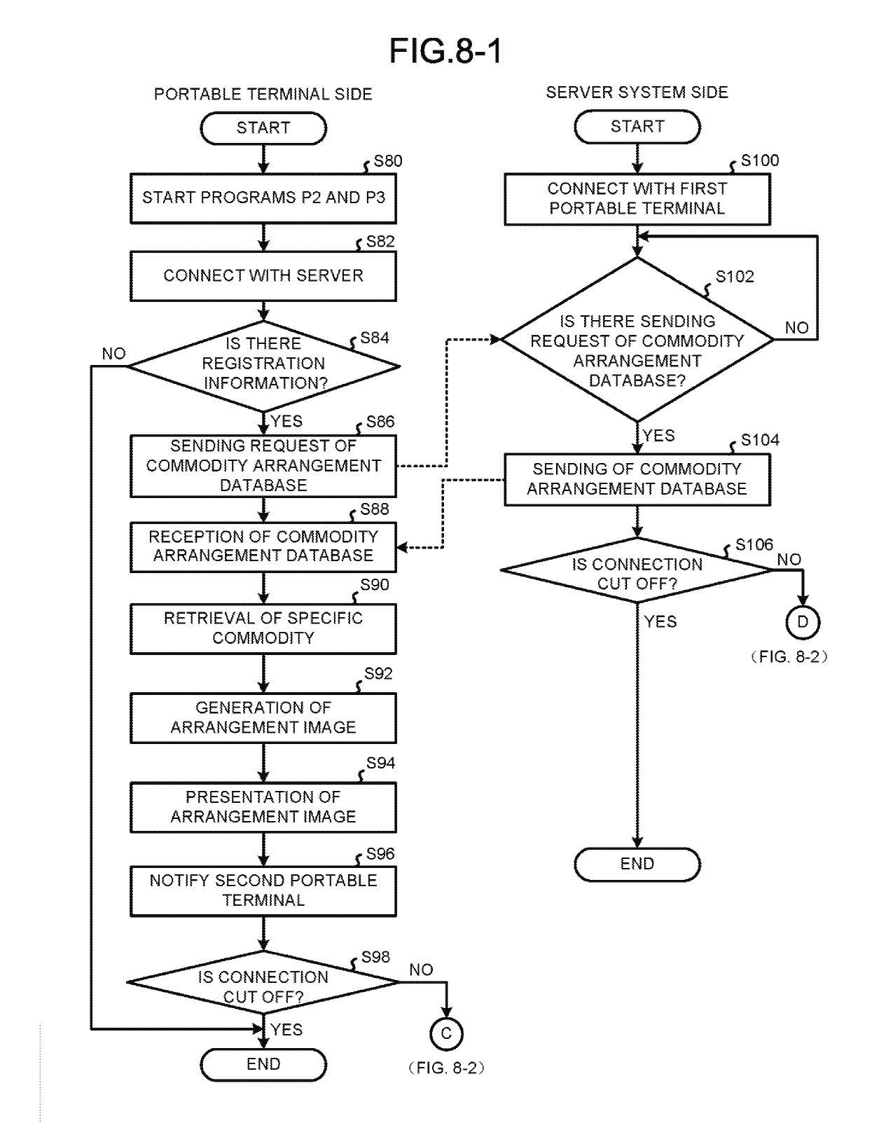

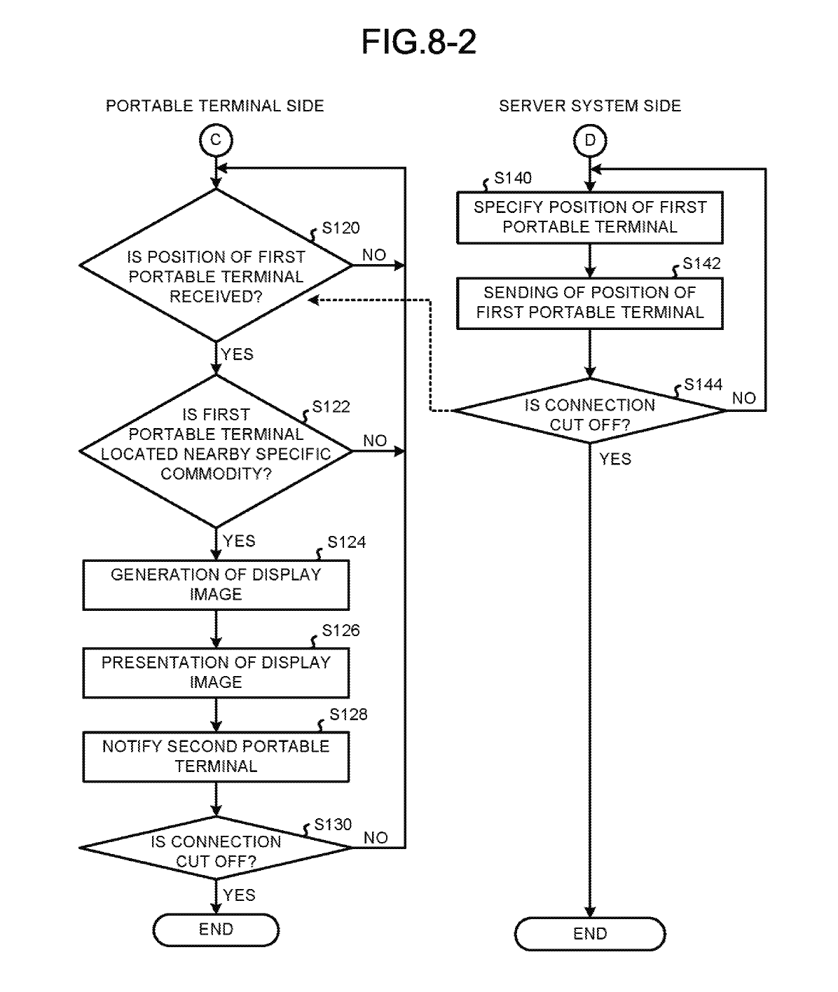

Next, the flow of the processing carried out by the shopping support system 100b is described with reference to flowcharts in FIG. 8-1 and FIG. 8-2. FIG. 8-1 illustrates the flow of the processing from a moment the customer C enters the store to a moment the arrangement image I1 is presented to the first portable terminal 52c. FIG. 8-2 illustrates the flow of the processing from a moment the arrangement image I1 is presented to the first portable terminal 52c to a moment the display image I2 is presented thereto.

The first portable terminal 52c receives an instruction of the customer C who comes to the store S to start the program P2 (FIG. 2), and furthermore, to start the program P3 (FIG. 2) of the second portable terminal 52b wirelessly connected with the first portable terminal 52c in advance (ACT S80). Then, the connection setting section 83 of the first portable terminal 52c connects the first portable terminal 52c with the server 5b via the wireless AP with the predetermined radio wave intensity among the plurality of the wireless APs 14a-14n (FIG. 1) (ACT S82).

The first portable terminal 52c confirms whether or not there is the registration information K of the customer C in the information registration section 82 (ACT S84). If it is confirmed that the registration information K of the customer C is registered in the information registration section 82 (YES in ACT S84), a processing in ACT S86 is executed, or if the registration information K of the customer C is not registered (No in ACT S84), the processing in FIG. 8-1 is ended.

The first portable terminal 52c requests the server 5b to send the commodity arrangement database 32 (ACT S86). Then, the first portable terminal 52c receives the commodity arrangement database 32 from the server 5b (ACT S88).

The specific commodity retrieval section 84b retrieves the specific commodity M (ACT S90). Then, the arrangement image generation section 86b generates the arrangement image I1 (ACT S92). The first portable terminal 52c presents the arrangement image I1 to the image presentation section 92 (ACT S94). The first portable terminal 52c notifies the second portable terminal 52b of the presentation of the arrangement image I1 (ACT S96).

The first portable terminal 52c confirms whether or not the connection with the server 5b is cut off (ACT S98). If the connection is cut off (YES in ACT S98), the processing in FIG. 8-1 is ended. Otherwise, No is taken in ACT S98 and a processing in ACT S120 is executed (FIG. 8-2).

The connection setting section 31 of the server 5b connects the server 5b with the first portable terminal 52c (ACT S100). The server 5b confirms whether or not there is the sending request of the commodity arrangement database 32 from the first portable terminal 52c (ACT S102). If there is the request (YES in ACT S102), a processing in ACT S104 is executed, or if there is no request (No in ACT S102), the processing in ACT S102 is repeated. The server 5b sends the commodity arrangement database 32 to the first portable terminal 52c (ACT S104).

The server 5b confirms whether or not the connection with the first portable terminal 52c is cut off (ACT S106). If the connection is cut off (YES in ACT S106), the processing in FIG. 8-1 is ended, or if the connection is not cut off (No in ACT S106), a processing in ACT S140 is executed (FIG. 8-2).

The first portable terminal 52c confirms whether or not the position of the first portable terminal 52c in the store S is received from the server 5b (ACT S120). If the position of the first portable terminal 52c is received (YES in ACT S120), a processing in ACT S122 is executed, or if the position of the first portable terminal 52c is not received (No in ACT S120), the processing in ACT S120 is repeated.

The specific commodity detection section 88b detects whether or not the first portable terminal 52c is located in the vicinity of the specific commodity M (ACT S122). If the first portable terminal 52c is located in the vicinity of the specific commodity M (YES in ACT S122), a processing in ACT S124 is executed, or if the first portable terminal 52c is not located in the vicinity of the specific commodity M (No in ACT S122), the processing in ACT S120 is re-executed. Though it is not shown in FIG. 8-2, in ACT S122, If the first portable terminal 52c is not located in the vicinity of the specific commodity M and the display image I2 is already presented to the first portable terminal 52c, it is determined that the customer C once comes to near the specific commodity M and then moves away therefrom. Based on this determination, the display image I2 being presented is erased, and the arrangement image I1 may be presented again.

The display image generation section 90b generates the display image I2 (ACT S124). Then, the first portable terminal 52c presents the display image I2 to the image presentation section 92 (ACT S126). Furthermore, the first portable terminal 52c notifies the second portable terminal 52b of the presentation of the display image I2 (ACT S128).

The first portable terminal 52c confirms whether or not the connection with the server 5b is cut off (ACT S130). If the connection is cut off (YES in ACT S130), the processing in FIG. 8-2 is ended, or if the connection is not cut off (No in ACT S130), the processing in ACT S120 is re-executed.

The customer position determination section 34 specifies the position of the first portable terminal 52c in the store S (ACT S140). The server 5b sends the specified position of the first portable terminal 52c to the first portable terminal 52c (ACT S142).

The server 5b confirms whether or not the connection with the first portable terminal 52c is cut off (ACT S144). If the connection is cut off (YES in ACT S144), the processing in FIG. 8-2 is ended, or if the connection is not cut off (No in ACT S144), the processing in ACT S140 is re-executed.

In this way, according to the shopping support system 100b of the second embodiment, the first portable terminal 52c includes the registration information reading section 33b, the specific commodity retrieval section 84b, the arrangement image generation section 86b, the specific commodity detection section 88b and the display image generation section 90b. The first portable terminal 52c receives the contents of the commodity arrangement database 32 and the position of the first portable terminal 52c (position of the customer C) in the store S from the server 5b to generate the arrangement image I1 and the display image I2. Therefore, as the server 5b does not generate the arrangement image I1 and the display image I2, the amount of calculation and calculation time of the server 5b can be reduced. With this operation, the reduction in a processing speed of the server 5b can be prevented even if many customers who come to the store S simultaneously operate the shopping support system 100b.

The allocation method of processing carried out between the server 5b and the first portable terminal 52c is not limited to that described in the second embodiment. For example, in the second embodiment, the commodity arrangement database 32 is sent from the server 5b to the first portable terminal 52c; however, it may be appropriate that the registration information K of the customer C is sent from the first portable terminal 52c to the server 5b, the retrieval of the specific commodity M is carried out by the server 5b and the retrieval result is sent to the first portable terminal 52c.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A shopping support system, comprising:
a registration information reading section configured to read registration information from an information holding module, in which the registration information of a customer is registered, carried by the customer who comes to a store;
a commodity arrangement database configured to store shelf allocation of commodities in the store;
a customer position determination section configured to specify a position of the customer in the store;
a specific commodity retrieval section configured to retrieve a specific commodity relating to the registration information and a display position of the specific commodity in the store from the commodity arrangement database;
a specific commodity detection section configured to detect whether or not there is the specific commodity in the vicinity of the customer on the basis of the position of the customer and the display position of the specific commodity in the store;
a display image generation section configured to generate a display image indicating a display state of the specific commodity if the specific commodity is detected in the vicinity of the customer by the specific commodity detection section; and
an image presentation section configured to present the display image to the customer.

2. The shopping support system according to claim 1, further comprising an arrangement image generation section configured to generate an arrangement image indicating the display position of the specific commodity in the store, wherein the image presentation section presents the arrangement image to the customer.

3. The shopping support system according to claim 2, wherein the information holding module is a first portable terminal which is carried by the customer and presents the display image or the arrangement image, and includes a second portable terminal for notifying the customer that the display image or the arrangement image is presented on the first portable terminal.

4. The shopping support system according to claim 3, wherein the customer position determination section specifies a position of the first portable terminal or the second portable terminal in the store.

5. A server, comprising:
a registration information reading section configured to read registration information from an information holding module, in which the registration information of a customer is registered, carried by the customer who comes to a store;
a commodity arrangement database configured to store shelf allocation of commodities in the store;
a customer position determination section configured to specify a position of the customer in the store;
a specific commodity retrieval section configured to retrieve a specific commodity relating to the registration information and a display position of the specific commodity in the store from the commodity arrangement database;
a specific commodity detection section configured to detect whether or not there is the specific commodity in the vicinity of the customer on the basis of the position of the customer and the display position of the specific commodity in the store; and
a display image generation section configured to generate a display image indicating a display state of the specific commodity if the specific commodity is detected in the vicinity of the customer by the specific commodity detection section.
